(19) United States
(12) Patent Application Publication
(10) Pub. No.: US 2009/0072749 A1
(43) Pub. Date: Mar. 19, 2009

(54) Image Intensifier with Adjustable Figure of Merit

(76) Inventor: Michael R. Saldana, New Braunfels, TX (US)

Correspondence Address: JACKSON WALKER, L.L.P., 112 E. PECAN, SUITE 2400, SAN ANTONIO, TX, 78205, US

(21) Appl. No.: 12/205,751

(22) Filed: Sep. 5, 2008

Related U.S. Application Data
(60) Provisional application No. 60/967,475, filed on Sep. 5, 2007.

(51) Int. Cl. H05B 37/02; H01J 31/49; G02B 27/00

(52) U.S. Cl. 315/158; 250/333; 250/551

(57) ABSTRACT

An image intensifier such as a night vision goggle includes a tube module and a power supply module. The image quality may be characterized by a figure known as the “Figure of Merit” (FOM), which is an arithmetic product of screen resolution and signal-to-noise ratio (SNR). Both resolution and SNR are affected by the voltage supplied by the power supply module. By providing a power supply module with an adjustable voltage, the FOM may be varied. The adjustment mechanism may then be rendered tamper resistant, thereby enabling the FOM to be permanently reduced for devices intended for export.

### CROSS REFERENCE TO RELATED APPLICATIONS

This application claims the benefit of U.S. provisional application 60/967,475, filed Sep. 5, 2007 and entitled “Image Intensifier with Adjustable Signal-to-Noise Ratio and Imaging Resolution and Method for its Operation and Production,” which is hereby incorporated by reference.

### BACKGROUND

This specification relates to the field of image intensifiers and more particularly to an image intensifier assembly with an adjustable figure of merit.

Image intensifiers for use in night vision systems commonly use a measurement called Figure of Merit (FOM) for image quality. FOM is the arithmetic product of the resolution, measured in line pairs per millimeter (lp/mm) and signal-to-noise ratio (SNR), which is unitless. Resolution typically varies in the range of 50 to 72 lp/mm. SNR typically varies in the range of 20 to 25. So FOM typically varies in the range of 1,000 to 1,800, with a higher FOM generally representing a superior overall image quality.

FOM may be important in some contexts because the United States government regulates the export of night vision systems by requiring that exported items have a FOM below a specified threshold. A common method of varying FOM is to provide a power supply that supplies a lower photocathode voltage, thus degrading both resolution and SNR.

### BRIEF DESCRIPTION OF THE DRAWINGS

FIG. 1 is a perspective view of a night vision system, which may employ an image intensifier constructed according to the present specification;

FIG. 1A is a perspective view of an image intensifier assembly for use with a night vision system;

FIG. 1B is a front view of a power supply for use with an image intensifier assembly;

FIG. 1C is a side view of an adjustment port that has been back filled to prevent tampering;

FIG. 2 is an electrical schematic of an exemplary prior art power supply;

FIG. 3 is an electrical schematic of an exemplary embodiment of an adjustable power supply in accordance with the present specification; and

FIG. 4 is an electrical schematic of an exemplary opto-coupler in accordance with the present specification.

### SUMMARY OF THE INVENTION

In one aspect, an image intensifier for a night vision system may include a tube module and a power supply module. The image quality may be characterized by a figure known as the “Figure of Merit” (FOM), which is an arithmetic product of center limiting resolution and signal-to-noise ratio (SNR). Both resolution and SNR are affected by the voltage supplied by the power supply module. By providing a power supply module with an adjustable photocathode voltage, the FOM may be varied. The adjustment mechanism may then be rendered tamper resistant, thereby enabling the FOM to be permanently reduced for devices intended for export.

### DETAILED DESCRIPTION OF THE EMBODIMENTS

An adjustable FOM is useful for creating image intensifiers that are suitable for export outside of the United States. An image intensifier according to the disclosure in this specification may include a mechanically-variable adjustment mechanism such as an adjustment screw, typically as part of an adjustment potentiometer.

Generally, a tube and a power supply may be encapsulated in a single package as an image intensifier for use with a night vision system. Because of variances inherent in the production process, it is difficult to predict in advance what FOM will be achieved by joining a particular tube to a particular power supply. But a mechanically-variable power supply can be joined with any tube and the FOM can then be adjusted accordingly. If a device is intended for export, the entire image intensifier assembly can be encapsulated in epoxy to ensure that the power supply cannot be separated from the tube without damage. After the final FOM adjustment, the adjustment screw or other mechanically-variable adjustment mechanism can be disabled. For example, an adjustment screw may be set with epoxy to ensure that it is securely fastened in position. The screw head can then be ground out to prevent any further manipulation, and the adjustment port can finally be back-filled with epoxy to prevent tampering.

An image intensifier with adjustable figure of merit will now be described with more particular reference to the attached drawings. Hereafter, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance or example of an element and the un-hyphenated form of the reference numeral refers to the element generically or collectively. Thus, for example, 102-1 may refer to a “pen,” which may be an instance or example of the class of “writing implements.” Writing implements may be referred to collectively as “writing implements 102” and any one may be referred to generically as a “writing implement 102.”

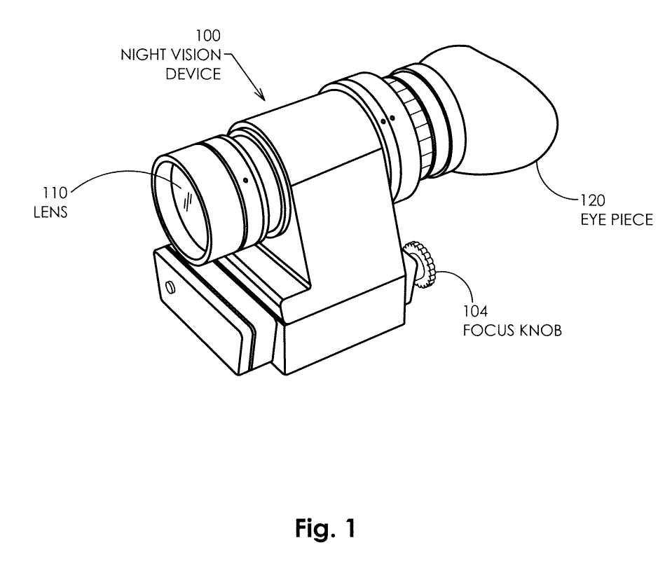

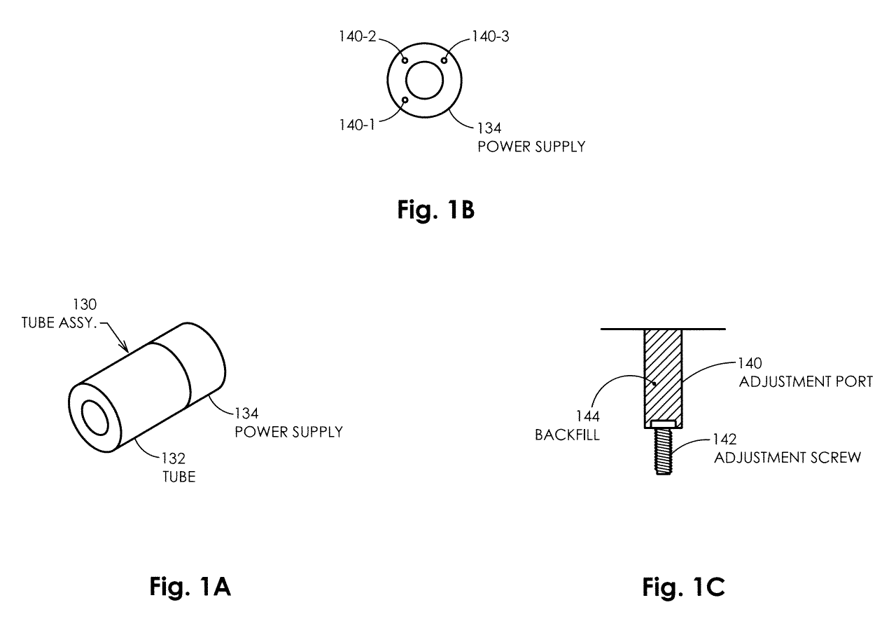

FIG. 1 discloses a perspective view of an night vision system 100, which may be include an image intensifier assembly built according to the present specification. Night vision system 100 includes a lens 110 for permitting light to enter and an eyepiece 120 for viewing by a user. A focus knob 104 allows adjustment of the sharpness of the image, but does not permit adjustment of the FOM. Contained within image intensifier 100 is an image intensifier assembly 130 (FIG. 1A). Image intensifier assembly 130 (FIG. 1A) receives light through lens 110. Its output is visible to a user through eyepiece 120. As is commonly known, night vision system 100 may also include batteries, assorted controls, and objective and eyepiece optics for interface with the user.

FIG. 1A is a perspective view of an image intensifier assembly 130 for use with a night vision system 100, and more particularly discloses the construction thereof. Image intensifier assembly 130 may include a tube 132 and a power supply 134. In some embodiments, tube 132 and power supply 134 may be permanently joined as a single unit. For example, tube 132 and power supply 134 may be bonded together with epoxy or other strong material that will prevent disassembly without damaging the components.

FIG. 1B is a front view of power supply 134, disclosing that power supply 134 may include a number of adjustment ports 140. Adjustment ports may enable adjustment of certain parameters after manufacture, including FOM. For example, adjustment ports 140-1 and 140-2 may be used for other purposes, while adjustment port 140-3 may allow for adjustment of FOM.

FIG. 1C is a side view of adjustment port 140-3. Adjustment screw 142 may be used to adjust FOM after manufacture of image intensifier assembly 130 (FIG. 1A). After final FOM adjustment has been completed, a small amount of epoxy may be used to permanently set adjustment screw 142. Once the epoxy has set, a portion of it may be ground out, and then the head of adjustment screw 142 may also be ground out. This prevents end users from tampering with the adjusted FOM. Finally, the cavity may be enclosed in backfill material 144. In some embodiments, hardened epoxy resin may be used. Other materials may also be used, for example, room-temperature vulcanizing (RTV) silicone rubber has been used in some applications. But softer materials such as RTV silicone rubber may be less effective in denying access to adjustment port 140-3.

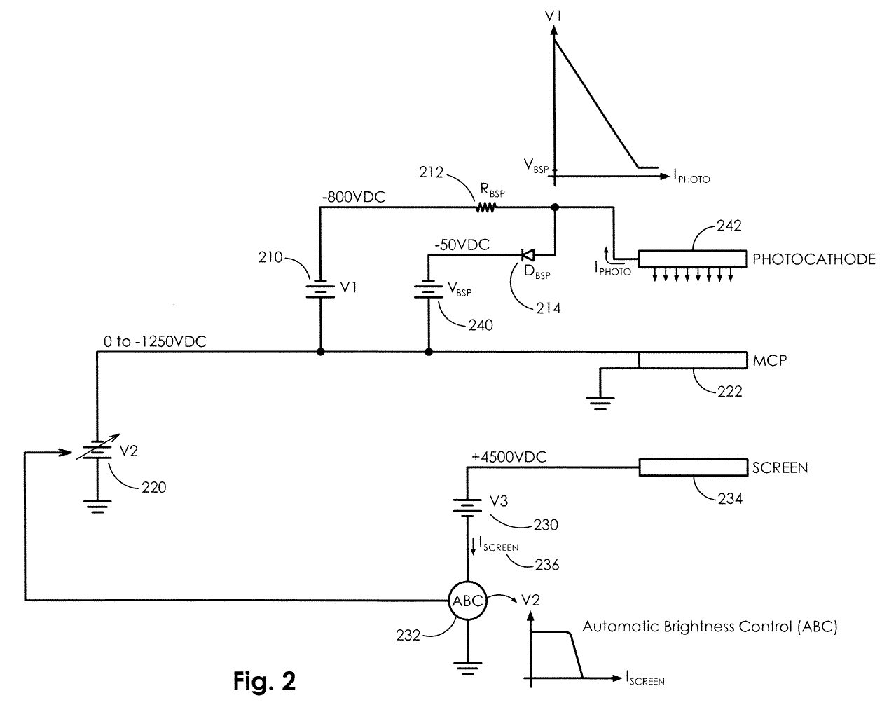

FIG. 2 is an electrical schematic of an exemplary prior art power supply with a non-adjustable photocathode voltage. Voltage supplies V1 210, V_{BSP} 240, V2 220 and V3 230 provide the basic biasing potentials needed for an image intensifier. V2 220 is an adjustable high voltage source used to bias the MCP 222, which can be adjusted via an external means to allow factory or user adjustability, as well as by internal Automatic Brightness Control (ABC) circuitry 232. ABC circuitry 232 senses the image intensifier's screen current 236, which is proportional to the screen's 236 brightness, and adjusts V2 220 to maintain a constant level of screen current 236 to prevent the output brightness from becoming too bright as a result of increasing input illumination. Typical adjustment range for V2 220 is −750 VDC to −1250 VDC for the external adjustment and 0 to −1250 VDC for the internal adjustment via the ABC circuit 232. V3 230 is a fixed high voltage source used to bias the image intensifier's screen 234. Typical V3 230 operating voltage is between +4,000 VDC and +6,000 VDC. V1 210 is a fixed high voltage source used to bias the image intensifier's photocathode 242. V1 210 is a floating potential referenced to V2 220, which is necessary to maintain the correct electrostatic field between the photocathode 242 and MCP 222 input independent of the operating level of V2 220, which is adjustable as described above. V_{BSP} 240, R_{BSP} 212, and D_{BSP} 214 work in conjunction to provide bright source protection (BSP) for the image intensifier 100. They do this by reducing the electrostatic potential between to photocathode 242 and MCP 222 to a predetermined level low enough to cause the vast majority of photoelectrons to be absorbed by the MCP's 222 ion barrier film, thus preventing an excessive flow of contaminating ions back toward the phtotocathode 242 from the MCP 222. This operation is accomplished by the combination of the clamping voltage V_{BSP} 240 (typically −30 to −60 VDC, with respect to V2 220) connected to the output side of R_{BSP} 212 (typically 5-18 GΩ) through a high voltage clamping diode D_{BSP} 214. During excessive input illumination, photocurrent flow through R_{BSP} 212 causes the D_{BSP} 214 to become forward biased, thereby conducting and effectively clamping the output voltage of R_{BSP} 212 to a fixed level.

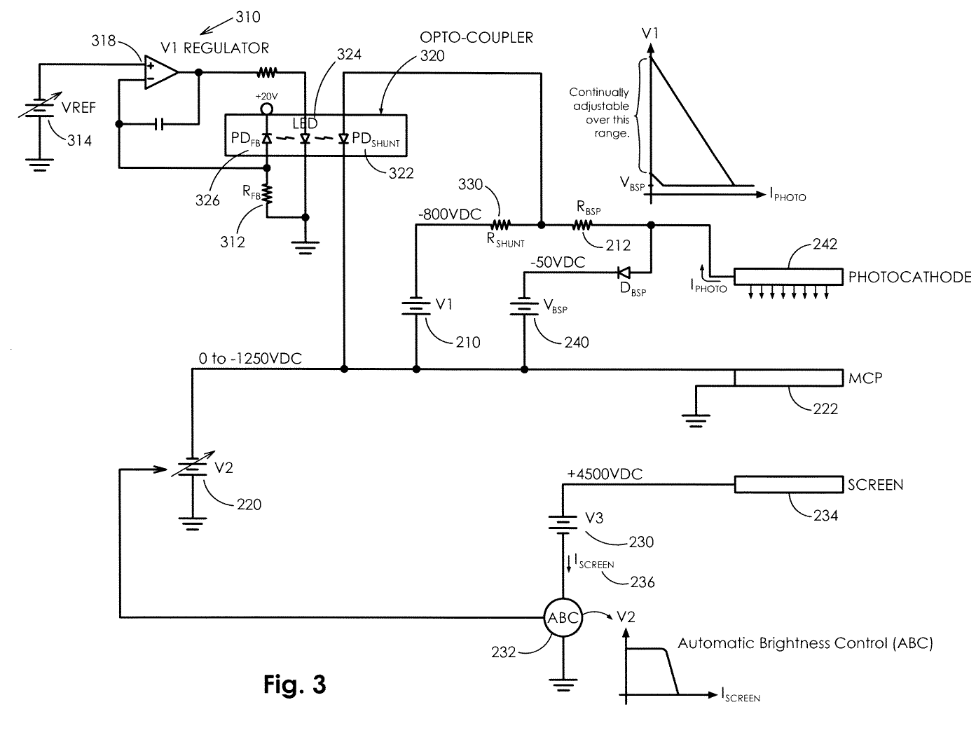

FIG. 3 is an electrical schematic of an exemplary embodiment of an adjustable power supply in accordance with the present specification. In this case, an additional network is added, which allows the user to make adjustments of the floating V1 bias potential using a ground-referenced, user-adjustable interface. The high voltage isolation element is a dual-detector opto-coupler 320, which consists of an LED emitter 324 monitored by two photodiodes PD_{FB} 326 and PD_{SHUNT} 322. PD_{FB} 326 provides a feedback current signal, which is sensed by a feedback resistor R_{FB} 312 for voltage input to the V1 regulator op-amp 318. It will be well within the ability of a person having ordinary skill in the art to select an appropriate resistor value for R_{FB} 326. PD_{SHUNT} 322 is a high voltage photodiode that produces a shunting current across R_{SHUNT} 330 located at the output of high voltage source V1 210 in response to light emanating from the LED 324. Photodiodes PD_{FB} 326 and PD_{SHUNT} 322 are of the same construction and are positioned so that the light emanating from the LED projects onto both. Accordingly, current through PD_{FB} 326 is proportional to the current through PD_{SHUNT} 322, and thus an indication of the voltage present at the circuit node between R_{SHUNT} 330 and R_{BSP} 212. By sensing and regulating the voltage developed across R_{FB} 312 produced by the current through PD_{FB} 326, the V1 regulator op-amp 318 regulates the voltage at the circuit node between R_{SHUNT} 330 and R_{BSP} 212, which is the voltage that is presented to the photocathode under low photocurrent (low light) conditions. Temperature drift effects of the LED and photodiodes, as well as aging effects on the current transfer ratios of the LED/photodiode combinations are effectively compensated by the fact that the photodiodes are of the same construction. Because the regulation is performed at ground level, rather than at a floating ground reference, user adjustment via variable resistor or other non-isolated means is possible.

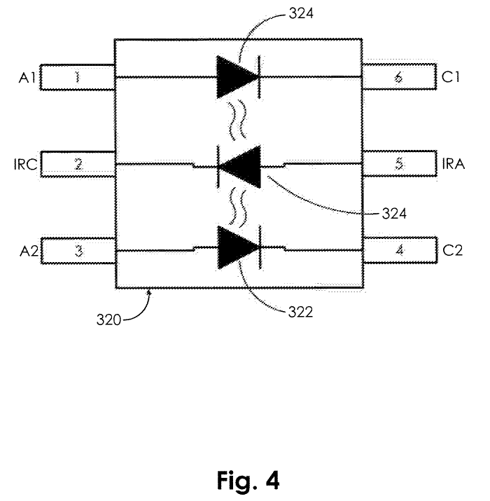

FIG. 4 is an electrical schematic of an exemplary opto-coupler 320 for use with an image intensifier as presently disclosed. In some embodiments, the opto-coupler 320 may be a single integrated circuit, such as Electronic Devices, Inc. part number ED2927. The following details are drawn to an exemplary opto-coupler only, and in no way are intended to limit the opto-coupler to the embodiment disclosed.

In this embodiment, the opt-coupler is capable of enduring any or all of the following specified parameter ratings for unlimited periods of time without any permanent degradation resulting in failure to meet the required specification:

TABLE 1
Minimum Ratings

| Paramter | Symbol | Requirement |
|---|---|---|
| Emitter | | |
| Reverse Voltage | VR | 5 V |
| Forward Current | IF | 50 mA |
| Power Dissipation | P₁ | 100 mW |
| Detector (each) | | |
| Peak Reverse Voltage | VPR | 1600 Vdc |
| Forward Current, | IF | 10 mA |
| Average | | |
| Forward Current, | IS | 1 A (one cycle, 8.3 msec) |
| Surge | | |
| Coupler | | |
| Isolation Test Voltage | | 3000 Vdc |
| (in insulating | | |
| atmosphere) | | |

In this embodiment, the electrical characteristics are as follows (all at an operating temperature of 23° C. unless otherwise noted):

TABLE 2
Electrical Characteristics

| Parameter | Symbol | Requirement |
|---|---|---|
| Operating Temperature | | −51° C. to +52° C. |
| Storage Temperature | | −51° C. to +85° C. |
| LED Emitter | | |
| Forward Voltage | VFD | 4 V max @ 1 mA |
| Reverse Current | IR | 10 nA max. @ 1200 Vdc |
| Detector (Each) | | |
| Forward Voltage | VFD | 4 V max. @ 1 mA |
| Drop | | |
| Reverse Current | IR | 10 nA max. @ 1200 Vdc |
| Coupler @ 3000 Vdc | | |
| Max. allowed leakage | IL | 3 nA |
| @ 3 kV dc (emitter | | |
| LED to either | | |
| detector) | | |
| Current Transfer | CTR | 0.02% min. @ IF = 1 mA |
| Ratio | | |

Opto-coupler 320 is capable of meeting all requirements after being subjected to 12 temperature cycles from +85° C. to −55° C. with two hour soaks at each temperature. The transition rate from −55° C. to +85° C. and from +85° C. to −55° C. is 3° C. per minute minimum. This requirement may be satisfied through sampling a single month's production per ANSI/ANSQCZI1.4-1993 Inspection Level S-1, 1.0 AQL.

As disclosed in this specification, a single batch of image intensifiers, built from a batch of tube modules and power supply modules, may be produced for both domestic use and export. After production is complete, some of the image intensifiers will be selected for export, and the FOM will be adjusted and fixed as described herein. A FOM may also be selected for image intensifiers identified for domestic use by providing the maximum possible photocathode current. To make the image intensifiers resistant to tampering, for example by an enemy wanting to increase the photocathode voltage to increase FOM, by disabling the adjustment mechanism. In one embodiment, the method of disabling includes backfilling the adjustment port with epoxy or other rigid material that will fix the adjustment mechanism in place. This renders the FOM fixed for that image intensifier. And because the entire image intensifier is encapsulated in epoxy, a new power supply cannot be substituted to increase the FOM. In a non-adjustable power supply, there are sometimes two holes in this epoxy that provide access to two adjustment screw-heads that are used to adjust two operating parameters (not FOM) of the night vision tube. After adjustment, these two cavities may be backfilled with soft RTV so that these adjustment screw heads are not accessible. But in some embodiments, epoxy or other more rigid material may be preferred for backfilling the adjustment mechanism for the photocathode voltage. For further security, after setting the adjustment mechanism in epoxy, part of the epoxy may be drilled out to provide access to the adjustment interface (such as a screw head on a potentiometer), which may also be disabled, for example by drilling out the screw head. The drilled-out adjustment port may then again be backfilled with epoxy. This provides redundant security for the adjustment mechanism.

Persons having skill in the art will recognize that there are numerous other methods for providing an adjustable voltage that can be disabled. For example, the mechanical adjustment mechanism, such as a screw, may receive a light coat of slow-acting adhesive (such as epoxy) before insertion, so that its position will be fixed after a time. In other embodiments, inserts may be used to physically block access to the port. In yet other embodiments, an electronic adjustment may be provided, and lead wires may be clipped or otherwise disabled before final encapsulation in epoxy, making the final product tamper resistant.

While the subject of this specification has been described in connection with one or more exemplary embodiments, it is not intended to limit the claims to the particular forms set forth. On the contrary, the appended claims are intended to cover such alternatives, modifications and equivalents as may be included within their spirit and scope.

What is claimed is:

1. An image intensifier with an adjustable figure of merit, the image intensifier comprising:
an image tube comprising a screen, a micro channel plate (MCP) and photocathode;
a high-voltage power supply capable of being electrically coupled to the image tube to provide supply voltages to the screen, MCP and photocathode;
the high-voltage power supply including a first voltage supplying voltage to the photocathode and known as the photocathode voltage;
the first voltage regulated by a voltage regulator assembly, the voltage regulator assembly including an opto-coupler electrically coupling the first voltage to a reference voltage;
wherein the image intensifier assembly is characterized by a figure of merit, the figure of merit being an arithmetic product of a signal to noise ratio and resolution, both of which are affected by variation of the photocathode voltage;
whereby the figure of merit is made adjustable by adjusting a mechanically variable control.

2. A method of producing a batch of image intensifiers wherein some items are designated for domestic use and others are designated for export, the method comprising the steps of:
producing a batch of power supplies;
producing a batch of tube modules;
permanently mating the power supplies to the tube modules, to form image intensifiers;
wherein at least some of the image intensifiers are encapsulated in a manner that they cannot be disassembled without damage;
identifying a first portion of the image intensifiers for export and preparing the first portion of image intensifiers for export, wherein preparing the first portion of image intensifiers comprises the steps of:
using an adjustment mechanism to adjust a voltage output of the power supplies to set a figure of merit (FOM) for the first portion of image intensifiers; and
disabling the adjustment mechanism; and
identifying a second portion of the image intensifiers for export and preparing the second portion of image intensifiers by selecting a voltage output to set a FOM.

3. A method of rendering an image intensifier with an adjustable parameter non-adjustable, the method comprising the steps of:
manipulating a mechanically-variable control of the image intensifier to achieve a desired parameter;
the mechanically-variable control residing in an adjustment port;
inhibiting manipulation of the mechanically-variable control;
whereby the mechanically-variable control is rendered unusable; and whereby usability of the mechanically-variable control is not restorable without damaging the mechanically-variable control.

4. The method of claim 3 wherein the rigid substance is epoxy resin.

5. The method of claim 3 wherein the rigid substance is silicone.

6. The method of claim 3 further comprising the steps of:
removing an interface mechanism from the mechanically-variable control to further inhibit manipulation; and
back filling the adjustment port with a rigid substance;
whereby access to the mechanically-variable control is further inhibited.

7. The method of claim 6 wherein the mechanically-variable control is a screw and the interface mechanism is a screw head; and wherein removing the interface mechanism comprises grinding down the screw head.

8. A variable power supply for an image intensifier module, the variable power supply comprising:
a high-voltage source;
a shunt resistor connected in series to an output of the high-voltage source;
an adjustable reference voltage supply;
a regulator operational amplifier receiving the reference voltage as a first input; and
an opto-coupler connected to an output of the operational amplifier, the opto-coupler comprising:
a light-emitting diode and two photodiodes capable of receiving signals from the light-emitting diode;
wherein one of the photodiodes acts as a feedback photodiode providing feedback to a second input of the operational amplifier and the other photodiode acts as a shunt photodiode;
wherein the shunt photodiode of the opto-coupler produces a shunting current across the shunt resistor.
